(19) United States
(12) Patent Application Publication
(10) Pub. No.: US 2015/0116473 A1
(43) Pub. Date: Apr. 30, 2015

(54) INFORMATION PROCESSING APPARATUS, INFORMATION PROCESSING METHOD, AND PROGRAM

(71) Applicant: SONY CORPORATION, Tokyo (JP)

(72) Inventors: Ryouhei YASUDA, Kanagawa (JP); Takuro NODA, Tokyo (JP); Maki IMOTO, Tokyo (JP)

(21) Appl. No.: 14/488,598

(22) Filed: Sep. 17, 2014

(30) Foreign Application Priority Data
Oct. 29, 2013 (JP) 2013-224418

(51) Int. Cl. G06K 9/00; G06Q 30/02

(52) U.S. Cl. CPC G06K 9/0061; G06Q 30/0242
USPC 348/78

(57) ABSTRACT

An information processing apparatus including an evaluation value calculation unit configured to calculate an evaluation value for each range identified based on information about a position of a line of sight of a user and range information indicating the range of calculating the evaluation value concerning the line of sight.

### CROSS REFERENCE TO RELATED APPLICATIONS

This application claims the benefit of Japanese Priority Patent Application JP 2013-224418 filed Oct. 29, 2013, the entire contents of which are incorporated herein by reference.

### BACKGROUND

The present disclosure relates to an information processing apparatus, an information processing method, and a program.

Technologies to obtain data on user's attention by using a technology related to detection of the line of sight such as the eye tracking technology have been developed. As the technologies to obtain data on user's attention, for example, the technology described in JP 2013-080365A and the technology described in JP 2007-286995A can be cited.

### SUMMARY

The method of calculating an evaluation value concerning the line of sight of a user based on the position of the line of sight of the user is not yet established.

In the present disclosure, a novel and improved information processing apparatus capable of calculating an evaluation value concerning the line of sight of a user based on the position of the line of sight of the user, an information processing method, and a program are proposed.

According to an embodiment of the present disclosure, there is provided an information processing apparatus including an evaluation value calculation unit configured to calculate an evaluation value for each range identified based on information about a position of a line of sight of a user and range information indicating the range of calculating the evaluation value concerning the line of sight.

According to another embodiment of the present disclosure, there is provided an information processing method executed by an information processing apparatus including calculating an evaluation value for each range identified based on information about a position of a line of sight of a user and range information indicating the range of calculating the evaluation value concerning the line of sight.

According to another embodiment of the present disclosure, there is provided a program causing a computer to execute calculating an evaluation value for each range identified based on information about a position of a line of sight of a user and range information indicating the range of calculating the evaluation value concerning the line of sight.

According to the present disclosure, an evaluation value concerning the line of sight of a user can be calculated based on the position of the line of sight of the user.

The above effect is not necessarily restrictive and together with the above effect or instead of the above effect, one of the effects shown in this specification or another effect grasped from this specification may be achieved.

### BRIEF DESCRIPTION OF THE DRAWINGS

FIG. 1 is an explanatory view showing an example of the range of calculating an evaluation value according to the present embodiment;

FIG. 2 is an explanatory view illustrating an example of processing according to an information processing method according to the present embodiment;

FIG. 3 is an explanatory view illustrating an example of processing according to the information processing method according to the present embodiment;

FIG. 4 is an explanatory view illustrating an example of processing according to the information processing method according to the present embodiment;

FIG. 5 is an explanatory view illustrating an example of processing according to the information processing method according to the present embodiment;

FIG. 6 is an explanatory view illustrating an example of processing according to the information processing method according to the present embodiment;

FIG. 7 is an explanatory view illustrating an example of processing according to the information processing method according to the present embodiment;

FIG. 8 is an explanatory view illustrating an example of processing according to an information processing method according to the present embodiment;

FIG. 9 is an explanatory view illustrating an example of processing according to the information processing method according to the present embodiment;

FIG. 10 is an explanatory view illustrating an example of processing according to the information processing method according to the present embodiment;

FIG. 11 is an explanatory view illustrating an example of processing according to the information processing method according to the present embodiment;

FIG. 12 is an explanatory view illustrating an example of processing according to the information processing method according to the present embodiment;

FIG. 13 is an explanatory view illustrating an example of processing according to the information processing method according to the present embodiment;

FIG. 14 is an explanatory view illustrating an example of an information processing system according to the present embodiment;

FIG. 15 is a block diagram showing an example of the configuration of an information processing apparatus according to the present embodiment; and

FIG. 16 is an explanatory view showing an example of a hardware configuration of the information processing apparatus according to the present embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be provided in the order shown below:

1. Information Processing Method According to the Present Embodiment

2. Information Processing Apparatus According to the Present Embodiment

3. Program According to the Present Embodiment

### Information Processing Method According to the Present Embodiment

Before describing the configuration of an information processing apparatus according to the present embodiment, an information processing method according to the present embodiment will first be described. The information processing method according to the present embodiment will be described by taking a case in which processing according to the information processing method according to the present embodiment is performed by an information processing apparatus according to the present embodiment as an example.

### Overview of Processing Related to an Information Processing Method According to the Present Embodiment

As described above, the method of calculating an evaluation value concerning the line of sight of a user based on the position of the line of sight of the user is not yet established.

Thus, the information processing apparatus according to the present embodiment calculates an evaluation value for each identified “range of calculating an evaluation value concerning the line of sight” based on, for example, information about the position of the line of sight of the user and range information indicating the range of calculating an evaluation value concerning the line of sight (evaluation value calculation processing). Hereinafter, the range of calculating an evaluation value concerning the line of sight may be represented as, for example, “the range of calculating an evaluation value according to the present embodiment”, “the range of calculating an evaluation value”, or “the range according to the present embodiment”.

### (a) Information About the Position of the Line of Sight of the User According to the Present Embodiment

Here, the information about the position of the line of sight of the user according to the present embodiment is, for example, data showing the position of the line of sight of the user or data that can be used to identify the position of the line of sight of the user (or data that can be used to estimate the position of the line of sight of the user. This also applies below).

As the data showing the position of the line of sight of the user according to the present embodiment, for example, coordinate data showing the position of the line of sight of the user on the display screen can be cited. The data showing the position of the line of sight of the user according to the present embodiment may include the data indicating the direction of the line of sight (for example, the data showing the angle with the display screen).

The position of the line of sight of the user on the display screen is represented by, for example, coordinates in a coordinate system in which a reference position of the display screen is set as its origin.

When coordinate data indicating the position of the line of sight of the user on the display screen is used as information about the position of the line of sight of the user according to the present embodiment, the information processing apparatus according to the present embodiment identifies the position of the line of sight of the user on the display screen by using, for example, coordinate data acquired from an external apparatus having identified (estimated) the position of the line of sight of the user by using the line-of-sight detection technology and indicating the position of the line of sight of the user on the display screen. When the data indicating the direction of the line of sight is used as information about the position of the line of sight of the user according to the present embodiment, the information processing apparatus according to the present embodiment identifies the direction of the line of sight by using, for example, data indicating the direction of the line of sight acquired from the external apparatus.

It is possible to identify the position of the line of sight of the user and the direction of the line of sight of the user on the display screen by using the line of sight detected by using the line-of-sight detection technology and the position of the user and the orientation of face with respect to the display screen detected from a captured image in which the direction in which images are displayed on the display screen is captured. However, the method of identifying the position of the line of sight of the user and the direction of the line of sight of the user on the display screen according to the present embodiment is not limited to the above method. For example, the information processing apparatus according to the present embodiment and the external apparatus can use any technology capable of identifying the position of the line of sight of the user and the direction of the line of sight of the user on the display screen.

As the line-of-sight detection technology according to the present embodiment, for example, a method of detecting the line of sight based on the position of a moving point (for example, a point corresponding to a moving portion in an eye such as the iris and the pupil) of an eye with respect to a reference point (for example, a point corresponding to a portion that does not move in the eye such as an eye's inner corner or corneal reflex) of the eye can be cited. However, the line-of-sight detection technology according to the present embodiment is not limited to the above technology and may be, for example, any line-of-sight detection technology capable of detecting the line of sight.

However, the data showing the position of the line of sight of the user according to the present embodiment is not limited to the above “coordinate data showing the position of the line of sight of the user on the display screen”.

When, for example, the user wears a transparent head mounted display (hereinafter, abbreviated as “HMD”), data showing the position of the line of sight of the user according to the present embodiment may be “coordinate data showing the position on a real object in a real space viewed by the user”.

The position on a real object in a real space viewed by the user is estimated by using, for example, a captured image in which the direction of the front (or a substantial front, this also applies below) of the user's face is captured and the line of sight detected by using the line-of-sight detection technology.

The captured image according to the present embodiment is an image in which the direction of the front of the user's face is captured and so corresponds to an image corresponding to a landscape actually viewed by the user. That is, the position on the real object in the real space viewed by the user can be estimated by, for example, identifying the position of the line of sight of the user in the captured image. When identifying the position of the line of sight of the user in the captured image, the estimation accuracy can be increased by making position corrections in consideration of displacements of the position of an imaging device capturing an image in which the direction of the front of the user's face is captured and the position of the user's eye.

However, the method of estimating the position on the real object in the real space viewed by the user is not limited to the above example and any technology capable of estimating the position on the real object in the real space viewed by the user can be used. Hereinafter, a case in which the position on the real object in the real space viewed by the user is estimated by using a captured image in which the direction of the front of the user's face is captured is taken as an example.

The position on the real object in the real space viewed by the user is represented by, for example, coordinates in a coordinate system in which the reference position in a captured image is set as the origin.

When, as information about the position of the line of sight of the user according to the present embodiment, coordinate data showing coordinates in a coordinate system in which the reference position in a captured image is set as the origin is used, an information processing apparatus according to the present embodiment identifies the position on the real object in the real space viewed by the user by using, for example, the coordinate data estimating the position on the real object in the real space viewed by the user and acquired from an external device.

As the data that can be used to identify the position of the line of sight of the user according to the present embodiment, for example, captured image data in which the direction in which images (moving images or still images) are displayed on the display screen is imaged can be cited. The direction in which images are displayed on the display screen according to the present embodiment is a direction on the side of the display screen on which, for example, images displayed on the display screen are viewed by the user. The data that can be used to identify the position of the line of sight of the user according to the present embodiment may further include detection data of any sensor obtaining detection values that can be used to improve estimation accuracy of the position of the line of sight of the user such as detection data of an infrared sensor that detects infrared radiation in the direction in which images are displayed on the display screen.

The data that can be used to identify the position of the line of sight of the user according to the present embodiment is not limited to captured image data in which the direction in which images are displayed on the display screen is captured. For example, data that can be used to identify the position of the line of sight of the user according to the present embodiment may be image data involved in detection of the line of sight of the user and image data involved in estimation of the position on the real object in the real space viewed by the user. As the image data involved in detection of the line of sight of the user, for example, captured image data captured such that user's eyes are contained in the image can be cited. As the image data involved in estimation of the position on the real object in the real space viewed by the user, for example, captured image data in which the direction of the front of the user's face is captured can be cited.

When data that can be used to identify the position of the line of sight of the user is used as information about the position of the line of sight of the user according to the present embodiment, the information processing apparatus according to the present embodiment uses, for example, captured image data (hereinafter, referred as the information processing apparatus according to the present embodiment) acquired by an imaging unit (described later) included in the local apparatus or an external imaging device. In the above case, the information processing apparatus according to the present embodiment may use, for example, detection data (example of data that can be used to identify the position of the line of sight of the user) acquired from a sensor that can be used to improve estimation accuracy of the position of the line of sight of the user included in the local apparatus or an external sensor. The information processing apparatus according to the present embodiment performs processing according to an identification method of the position of the line of sight of the user and the direction of the line of sight of the user on the display screen according to the present embodiment using, for example, data that can be used to identify the position of the line of sight of the user acquired as described above to identify the position of the line of sight of the user and the direction of the line of sight of the user on the display screen. The information processing apparatus according to the present embodiment also performs processing related to an estimation method of the position on a real object in the real space viewed by the user using, for example, data that can be used to identify the position of the line of sight of the user acquired as described above to estimate the position on the real object in the real space viewed by the user and to identify the position.

### (b) Range Information According to the Present Embodiment

Range information according to the present embodiment is data showing the range of calculating an evaluation value according to the present embodiment. Range information according to the present embodiment adopts any data format that can represent, for example, the range of calculating an evaluation value according to the present embodiment.

The information processing apparatus according to the present embodiment identifies the range of calculating an evaluation value based on range information stored in, for example, a storage unit (described later) included in the information processing apparatus according to the present embodiment or a connected external recording medium. The information processing apparatus according to the present embodiment can also identify the range of calculating an evaluation value based on range information acquired from a communicable external device.

The range information according to the present embodiment may be generated by, for example, the information processing apparatus according to the present embodiment and/or an external device and the information processing apparatus according to the present embodiment may identify the range of calculating an evaluation value based on the generated range information. An example of processing related to generation (generation processing) of the range information according to the present embodiment will be described later.

The information processing apparatus according to the present embodiment identifies, for example, the range indicated by the range information as the range of calculating an evaluation value according to the present embodiment.

However, the method of identifying the range of calculating an evaluation value by the information processing apparatus according to the present embodiment is not limited to the above example. The information processing apparatus according to the present embodiment may adjust the range indicated by range information and identify the adjusted range as the range of calculating an evaluation value. An example of processing related to adjustments of the range indicated by range information will be described later.

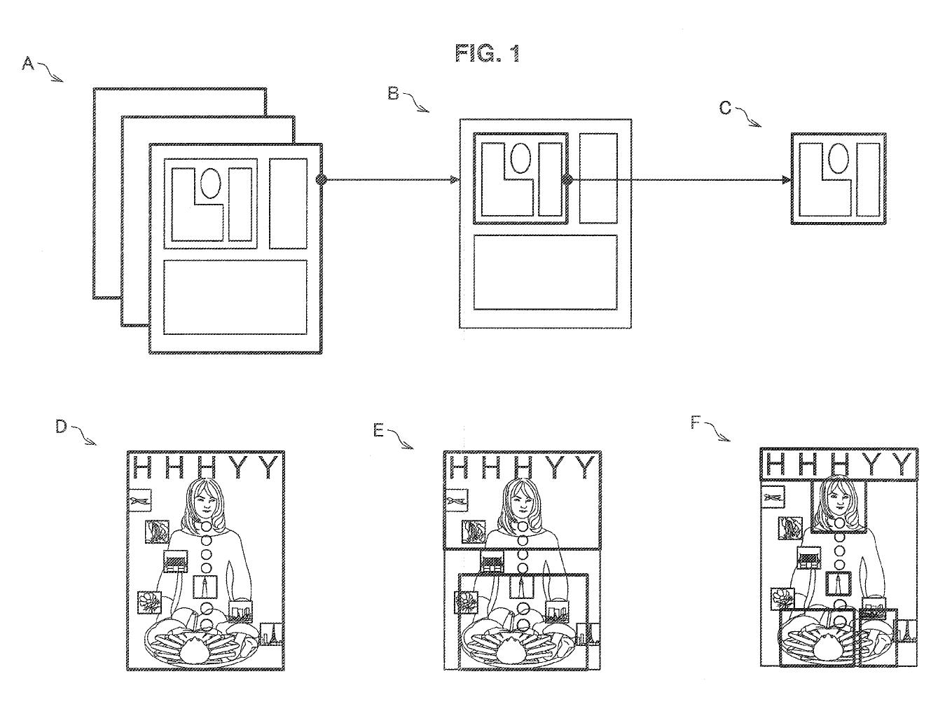

FIG. 1 is an explanatory view showing an example of the range of calculating an evaluation value according to the present embodiment. FIG. 1 shows an example in which the object to which the range of calculating an evaluation value is set is a medium having a plurality of pages such as a magazine, a book or the like.

However, the object to which the range of calculating an evaluation value is set is not limited to a medium having a plurality of pages such as a magazine, a book or the like. For example, the object to which the range of calculating an evaluation value is set may be any object that can be displayed on the display screen such as a still image, a moving image (or a plurality of still images. this also applies below) or the like. In addition, the object to which the range of calculating an evaluation value is set may be, for example, a real object in the real space.

As the range of calculating an evaluation value according to the present embodiment, as shown, for example, in A of FIG. 1, a page unit such as one page or a plurality of pages can be cited. If the object to which the range of calculating an evaluation value according to the present embodiment is set is a moving image, a predetermined unit in the moving image such as one frame, a plurality of frames or the like corresponds to the example shown in A of FIG. 1.

The range of calculating an evaluation value according to the present embodiment may be, as shown, for example, in B of FIG. 1, an article unit contained in one page or, as shown, for example, in C of FIG. 1, a constituent element unit of an article. When the range of calculating an evaluation value according to the present embodiment is any object that can be displayed on the display screen, a partial region of the region corresponding to the display screen corresponds to the example shown in B of FIG. 1 or the example shown in C of FIG. 1.

D to F of FIG. 1 show an example in which the range of calculating an evaluation value according to the present embodiment is the whole region corresponding to the display screen and examples in which the range is a partial region of the region corresponding to the display screen.

The range of calculating an evaluation value according to the present embodiment may be, as shown in D of FIG. 1, the whole region corresponding to the display screen or as shown in E, F of FIG. 1, a partial region of the region corresponding to the display screen.

As the range of calculating an evaluation value according to the present embodiment, for example, examples shown in FIG. 1 can be cited. However, it is needless to say that the range of calculating an evaluation value according to the present embodiment is not limited to examples shown in FIG. 1.

The information processing apparatus according to the present embodiment calculates an evaluation value for each range indicated by range information based on, for example, the information about the position of the line of sight of the user shown in (a) above and the range information shown in (b) above.

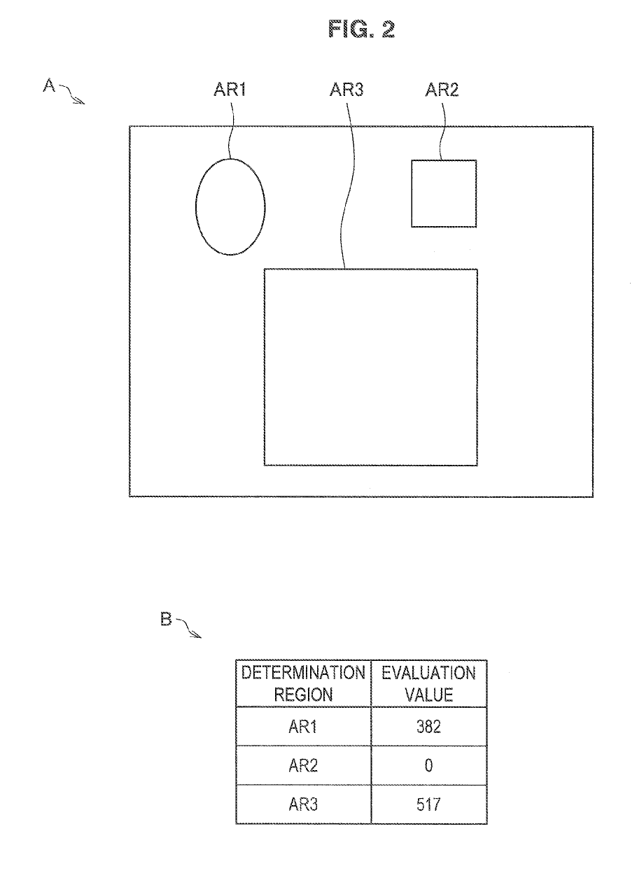

FIG. 2 is an explanatory view illustrating an example of processing related to an information processing method according to the present embodiment.

A shown in FIG. 2 shows an example of the range of calculating an evaluation value according to the present embodiment and a case in which the range of calculating an evaluation value according to the present embodiment is partial regions AR1 to AR3 of the region corresponding to the display screen. As the shape of the region when, as shown in A of FIG. 2, the range of calculating an evaluation value according to the present embodiment is a partial region of the region corresponding to the display screen, regions of various shapes such as rectangular and elliptic shapes can be cited.

B shown in FIG. 2 shows an example of an evaluation value calculated for each of the regions AR1 to AR3 shown in A of FIG. 2. Evaluation values as shown in B of FIG. 2 can be used, for example, for sorting in applications. An example of processing (execution processing) using evaluation values according to the present embodiment will be described later.

The information processing apparatus according to the present embodiment calculates, as shown, for example, in B of FIG. 2, an evaluation value for each range for which an evaluation value according to the present embodiment is calculated by performing processing related to the information processing method according to the present embodiment.

Hereinafter, the processing related to the information processing method according to the present embodiment will be described more concretely.

Processing related to the information processing method according to the present embodiment

(1) Evaluation Value Calculation Process

The information processing apparatus according to the present embodiment calculates an evaluation value for each identified range for which an evaluation value according to the present embodiment is calculated based on, for example, information about the position of the line of sight of the user and range information.

(1-1) First Example of the Evaluation Value Calculation Process

The information processing apparatus according to the present embodiment calculates an evaluation value according to the present embodiment by, for example, “coordinates (coordinates indicating the position on the display screen or coordinates indicating the position on a real object) in the range of calculating an evaluation value according to the present embodiment identified based on range information” and a “score value of the line of sight attached to the coordinates”.

More specifically, each time coordinates corresponding to the position of the line of sight (hereinafter, may be referred to as “line-of-sight coordinates”) of the user identified based on information about the position of the line of sight of the user according to the present embodiment is acquired, the information processing apparatus according to the present embodiment adds a score value by including coordinates around line-of-sight coordinates. As an example of the calculation method of a score value to be added, for example, a method of setting the highest addition value for the line-of-sight coordinates and decreasing the addition value with an increasing distance from the line-of-sight coordinates.

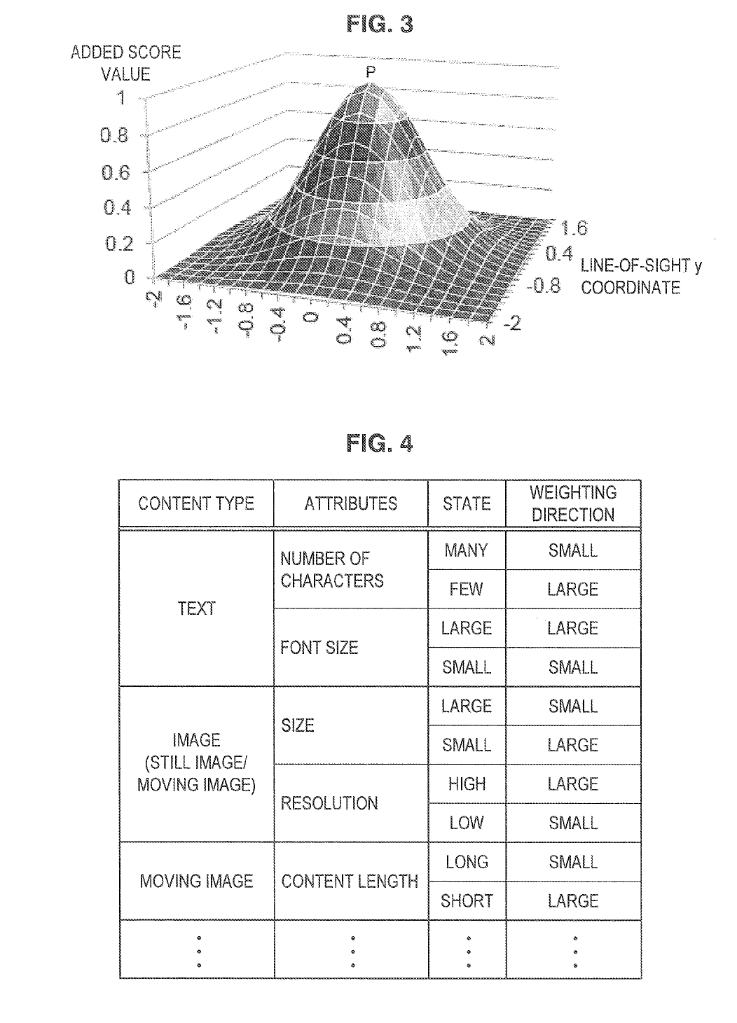

FIG. 3 is an explanatory view illustrating an example of processing related to the information processing method according to the present embodiment and shows an example of the calculation method of a score value to be added related to addition of an evaluation value according to the present embodiment.

If a method of decreasing the score value to be added concentrically around line-of-sight coordinates P when an xy plane as shown in FIG. 3 is viewed from above, the information processing apparatus according to the present embodiment performs an operation shown in, for example, Formula 1 below. “Score(x, y)” shown in Formula 1 shows the score value to be added at coordinates (x, y).

Score(x, y)=e^{-(x}^{²}^{+y}^{²}⁾ (Formula 1)

An evaluation value in each range for which an evaluation value according to the present embodiment is calculated can be calculated by a score value to be added being calculated as shown, for example, in Formula 1 above and the score value being added within the identified range for which an evaluation value is calculated according to the present embodiment. The information processing apparatus according to the present embodiment can also calculate a score value for each coordinate by, for example, adding for each coordinate a score value to be added and corresponding to each coordinate. Hereinafter, a value related to calculation of an evaluation value, for example, a score value according to the present embodiment and to be added or a score value according to the present embodiment for each coordinate may be represented as a “score value related to calculation of an evaluation value”.

The range of calculating an evaluation value according to the present embodiment is identified, for example, before a score value is calculated. With the range of calculating an evaluation value according to the present embodiment being identified before a score value is calculated, for example, the evaluation value can be analyzed in real time.

The range of calculating an evaluation value according to the present embodiment may also be identified after a score value is calculated. A case when the range of calculating an evaluation value according to the present embodiment is identified after a score value is calculated corresponds to, for example, an ex post analysis of the evaluation value.

Hereinafter, the timing when the information processing apparatus according to the present embodiment identifies the range of calculating an evaluation value according to the present embodiment is not specifically mentioned, but the information processing apparatus according to the present embodiment can also identify the range of calculating an evaluation value, for example, in the same timing as the above case in other examples of the evaluation value calculation process according to the present embodiment.

The calculation method of an evaluation value according to the present embodiment is not limited to the first example shown above.

(1-2) Second Example of the Evaluation Value Calculation Process

The information processing apparatus according to the present embodiment can also calculate an evaluation value by, for example, assigning weights to the identified range according to the present embodiment. The information processing apparatus according to the present embodiment assigns weights to, for example, each identified range according to the present embodiment. The information processing apparatus according to the present embodiment can also assign weights to, for example, a portion of the identified range according to the present embodiment.

(1-2-1) First Example of the Evaluation Value Calculation Process According to the Second Example

The information processing apparatus according to the present embodiment calculates an evaluation value by assigning weights based on, for example, one or both of the “type of content” and “attributes of content” contained in the identified range according to the present embodiment.

FIG. 4 is an explanatory view illustrating an example of processing related to the information processing method according to the present embodiment and shows an example of a table (or a database. this also applied below) used when the information processing apparatus according to the present embodiment assigns weights to calculate an evaluation value. The information processing apparatus according to the present embodiment uses, for example, a table stored in a storage unit (described later) or an external recording medium or a table acquired from a communicable external device.

Even if the identified range of calculating an evaluation value according to the present embodiment is the same, the time necessary for the user to understand may be different depending on the type of content contained in the range. The types of content according to the present embodiment include, for example, as shown in FIG. 4, text, images (still images/moving images), and moving images.

For example, when sentences (corresponding to text shown in FIG. 4) and images (corresponding to images or moving images shown in FIG. 4) are compared, more time is assumed to be necessary to understand sentences. Thus, if evaluation values are calculated for a first range according to the present embodiment containing more sentences and a second range according to the present embodiment containing more images and having the same size as the first range without assigning weights, calculated evaluation values may be different from an actual focused sense of the user.

Even if the type of content contained in the identified range of calculating an evaluation value according to the present embodiment is the same, the time necessary for the user to understand may be different depending on the attributes of content. The attributes of content according to the present embodiment include, for example, as shown in FIG. 4, indices corresponding to the type of content such as the number of characters and font size (example when the type of content is text) or the size and resolution (example when the type of content is an image).

Thus, the information processing apparatus according to the present embodiment changes weights based on one or both of the “type of content” and “attributes of content” contained in the identified range according to the present embodiment using a table as shown, for example, FIG. 4. By changing weights based on one or both of the “type of content” and “attributes of content” contained in the identified range according to the present embodiment, the calculated evaluation value can be brought closer to an actual focused sense of the user.

It is needless to say that an example of the table used by the information processing apparatus according to the present embodiment for assigning weights is not limited to the example shown in FIG. 4.

Data used by the information processing apparatus according to the present embodiment for assigning weights is not limited to the tabular form or database form. The information processing apparatus according to the present embodiment can use data of any form capable of assigning weights corresponding to, for example, the “type of content” and/or “attributes of content”.

(1-2-2) Second Example of the Evaluation Value Calculation Process According to the Second Example

When, for example, the range indicated by range information is a partial region of the region corresponding to the display screen as shown in A of FIG. 2, the information processing apparatus according to the present embodiment can calculate an evaluation value by assigning weights based on the distance from the reference position on the display screen in a region corresponding the identified range based on the range information.

As the reference position according to the present embodiment, for example, a preset position on the display screen (for example, the center position of the display screen or a position at a screen edge of the display screen) can be cited. The preset position on the display screen may be changeable based on, for example, a user's operation.

However, the reference position according to the present embodiment is not limited to a preset position on the display screen. For example, the reference position according to the present embodiment may be set based on the type of content set in a range identified based on range information. As the reference position set based on the type of content, for example, the position in accordance with a method of double-page spread of magazines or books like comic books can be cited.

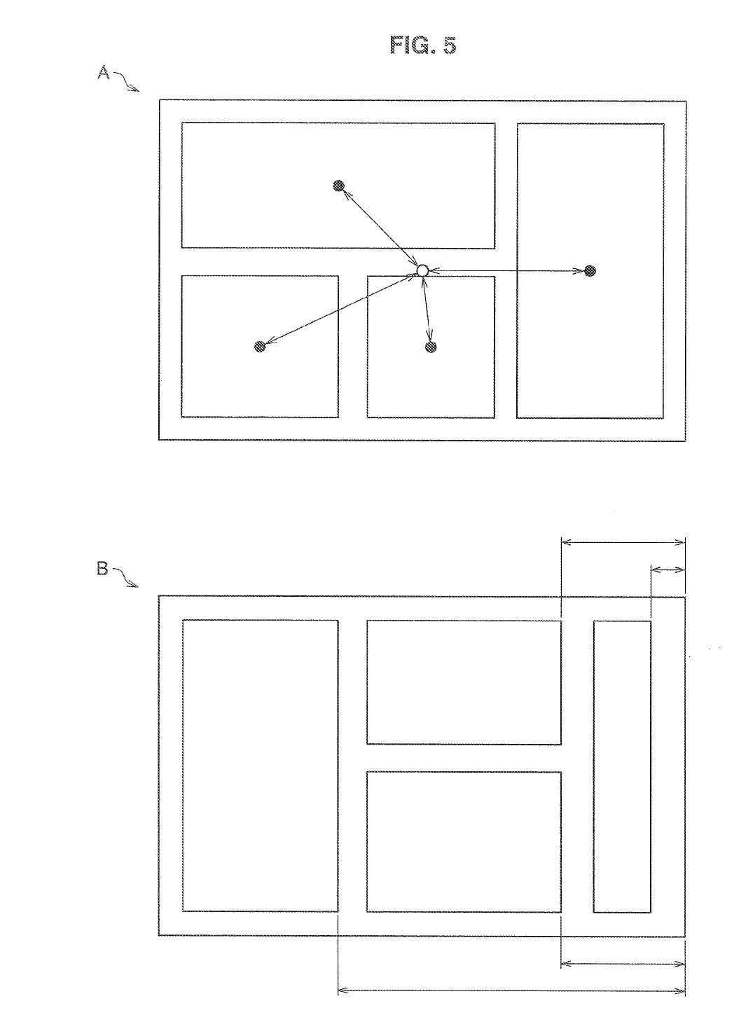

FIG. 5 is an explanatory view illustrating an example of processing related to the information processing method according to the present embodiment. FIG. 5 shows an example when the information processing apparatus according to the present embodiment calculates an evaluation value by assigning weights based on the distance from the reference position on the display screen.

A shown in FIG. 5 shows an example in which the reference position according to the present embodiment is the center position of the display screen. The example in A of FIG. 5 is an example when, for example, the center position of the display screen is considered to be a place more likely to become a focus of attention of the user.

When, as shown in A of FIG. 5, the center position of the display screen is set as the reference position according to the present embodiment, for example, the information processing apparatus according to the present embodiment increases weights with an increasing distance from the center position. The reason why weights are increased with an increasing distance from the center position is based on, for example, the idea that a region with an increasing distance from the center position of the display screen is originally less likely to become a focus of attention.

A of FIG. 5 shows an example in which the distance between the center position of the display screen and a region is based on the center position of the region, but the distance between the center position of the display screen and a region may be based on, for example, any position in the region.

B shown in FIG. 5 shows an example in which the reference position according to the present embodiment is a position at a screen edge of the display screen. The example in B of FIG. 5 is an example when, for example, a position on the right end of the display screen (example of the position at a screen edge of the display screen) is considered to be a place more likely to become a focus of attention of the user. A case when the position on the right end of the display screen is considered to be a place more likely to become a focus of attention of the user is, for example, an example assuming that content displayed on the display screen is read by the user from the right side facing the display screen.

When, as shown in B of FIG. 5, the position on the right end of the display screen is set as the reference position according to the present embodiment, for example, the information processing apparatus according to the present embodiment increases weights with an increasing distance from the position on the right end. The reason why weights are increased with an increasing distance from the position on the right end is based on, for example, the idea that a region with an increasing distance from the position on the right end of the display screen is originally less likely to become a focus of attention.

B of FIG. 5 shows an example in which the distance between the position on the right end of the display screen and a region is based on the position on the right end of the region, but the distance between the position on the right end of the display screen and a region may be based on, for example, any position in the region.

The calculation method of an evaluation value according to the present embodiment is not limited to the first example and the second example shown above.

(1-3) Third Example of the Evaluation Value Calculation Process

If, for example, the range indicated by range information is a partial region of the region corresponding to the display screen as shown in A of FIG. 2, the information processing apparatus according to the present embodiment identifies the range according to the present embodiment by adjusting the range indicated by the range information such that the range increases after each range. Here, the information processing apparatus according to the present embodiment adjusts the range indicated by the range information such that the range increases, for example, in the horizontal direction (one direction or both directions) and/or the vertical direction (one direction or both directions). Hereinafter, the region corresponding to the range indicated by range information may be represented as a “determination region”.

Then, the information processing apparatus according to the present embodiment calculates an evaluation value for each identified range (range after adjusting the range indicated by range information) according to the present embodiment like, for example, the above evaluation value calculation process according to the first example.

The accuracy of the calculated evaluation value may deteriorate, for example, for reasons given below:

Based on the accuracy of a device involved in the line-of-sight detection, a displacement between the position actually viewed by the user and the detected position of the line of sight may arise. Due to the above displacement, even if the user thinks that he (she) is viewing inside a range according to the present embodiment, the position of the line of sight based on information about the position of the line of sight of the user may indicate a position just outside the range according to the present embodiment.

Even if the user thinks that he (she) is viewing inside a range according to the present embodiment, the position of the line of sight based on information about the position of the line of sight of the user may indicate a position just outside the range according to the present embodiment due to fine eye movement.

Thus, the information processing apparatus according to the present embodiment attempts to improve the accuracy of the calculated evaluation value by adjusting the range indicated by range information such that the range increases after each range. Hereinafter, a concrete example of the evaluation value calculation process according to the third example will be described.

(1-3-1) First Example of the Evaluation Value Calculation Process According to the Third Example

If, for example, the score value for a range set from the range indicated by range information is larger than a predetermined determination threshold (or equal to or larger than a predetermined determination threshold. this also applies below), the information processing apparatus according to the present embodiment adjusts the range indicated by the range information to increase the range such that a score value larger than the set determination threshold is contained. The determination threshold according to the present embodiment may be, for example, a preset fixed value or a variable value that can be adjusted by a user's operation.

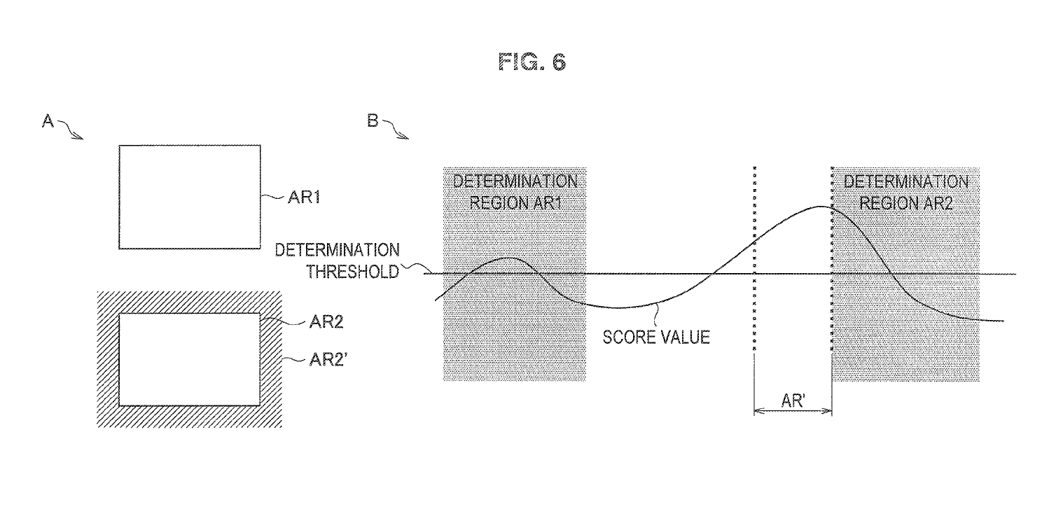

FIG. 6 is an explanatory view illustrating an example of processing related to the information processing method according to the present embodiment. FIG. 6 shows an example of the range indicated by range information and adjusted by the information processing apparatus according to the present embodiment in the first example of the evaluation value calculation process according to the third example.

A shown in FIG. 6 shows an example in which adjustments are made such that, of a region AR1 corresponding to range information and a region AR2, the region AR2 becomes larger in both directions of each of the horizontal direction and the vertical direction. A region AR2′ shown in A of FIG. 6 corresponds to the range according to the present embodiment after being adjusted. B shown in FIG. 6 shows an example when adjustments are made such that the region AR2 shown in A of FIG. 6 becomes larger to the left side in FIG. 6 (example of one direction in the horizontal direction).

In the example shown in B of FIG. 6, for example, the score value in a range AR′ set from the region AR2 is larger than the predetermined determination threshold and thus, the information processing apparatus according to the present embodiment increases the region AR2 by the range AR′.

After adjustments being made such that, as shown, for example, in FIG. 6, the range indicated by range information is increased, when the range according to the present embodiment is identified, the information processing apparatus according to the present embodiment can calculate an evaluation value by assigning weights to a range corresponding to a difference between, among adjusted ranges, an adjusted range and the range indicated by range information.

Processing related to weight assignment to the range corresponding to a difference between the adjusted range and the range indicated by range information may be performed in another process of the evaluation value calculation process according to the third example described later.

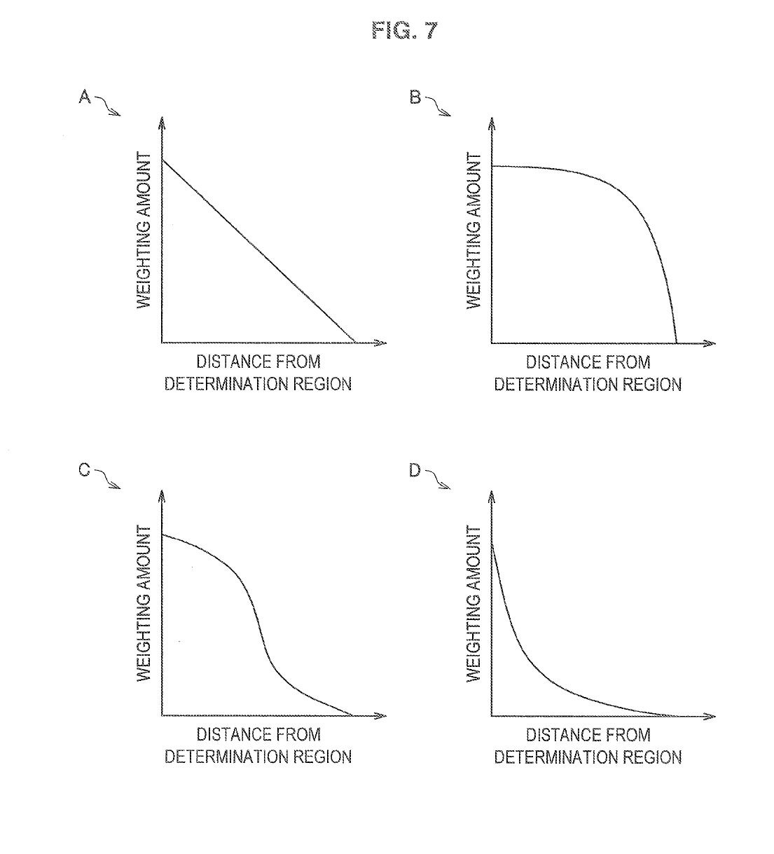

FIG. 7 is an explanatory view illustrating an example of processing related to the information processing method according to the present embodiment. A to D shown in FIG. 7 show examples of weight assignments to the range corresponding to a difference between the adjusted range and the range indicated by range information performed by the information processing apparatus according to the present embodiment.

The information processing apparatus according to the present embodiment uses, for example, data indicating a function stored in a storage unit (described later) or an external recording medium or data indicating a function acquired from a communicable external device. The information processing apparatus according to the present embodiment may also use, for example, a table (or a database) stored in a storage unit (described later) or an external recording medium and in which the distance and weights are associated or the table acquired from a communicable external device.

It is needless to say that examples of weight assignments to the range corresponding to a difference between the adjusted range and the range indicated by range information performed by the information processing apparatus according to the present embodiment are not limited to examples shown in FIG. 7.

(1-3-2) Second Example of the Evaluation Value Calculation Process According to the Third Example

The information processing apparatus according to the present embodiment may adjust the range indicated by range information based on, for example, the type of device corresponding to information about the position of the line of sight of the user. The device corresponding to information about the position of the line of sight of the user according to the present embodiment corresponds to, for example, an apparatus corresponding to the display screen to which the user directs his (her) line of sight.

If the device corresponding to information about the position of the line of sight of the user according to the present embodiment is, for example, a TV set, HMD or the like, the physical relationship between the user's eye and the device is hardly displaced. On the other hand, if the device corresponding to information about the position of the line of sight of the user according to the present embodiment is, for example, a tablet apparatus or a communication apparatus such as a smartphone, the physical relationship between the user's eye and the device is likely to be displaced.

Thus, if the device corresponding to information about the position of the line of sight of the user according to the present embodiment is an apparatus in which the physical relationship between the user's eye and the device is hardly displaced, for example, the information processing apparatus according to the present embodiment makes the amount of adjustments of the range indicated by range information smaller than that of an apparatus in which the physical relationship between the user's eye and the device is likely to be displaced. Also if the device corresponding to information about the position of the line of sight of the user according to the present embodiment is an apparatus in which the physical relationship between the user's eye and the device is hardly displaced, for example, the information processing apparatus according to the present embodiment does not adjust the range indicated by range information.

If the device corresponding to information about the position of the line of sight of the user according to the present embodiment is an apparatus in which the physical relationship between the user's eye and the device is likely to be displaced, for example, the information processing apparatus according to the present embodiment makes the amount of adjustments of the range indicated by range information larger than that of an apparatus in which the physical relationship between the user's eye and the device is hardly displaced.

More specifically, the information processing apparatus according to the present embodiment acquires, for example, data (for example, the device ID or the like) indicating the type of device corresponding to the information about the position of the line of sight of the user according to the present embodiment. The information processing apparatus according to the present embodiment acquires data indicating the type of device corresponding to the information about the position of the line of sight of the user according to the present embodiment by, for example, communicating with a device corresponding to information about the position of the line of sight of the user according to the present embodiment or a server that manages devices corresponding to information about the position of the line of sight of the user according to the present embodiment (example of the acquisition method when the device corresponding to information about the position of the line of sight of the user according to the present embodiment is an external device). If data indicating the type of device corresponding to information about the position of the line of sight of the user according to the present embodiment can be acquired, the acquisition method of data indicating the type of the device is not limited.

Then, the information processing apparatus according to the present embodiment identifies the amount of adjustments of the range corresponding to the acquired data indicating the type of device by using, for example, a table (or a database) associating data indicating the type of device and the amount of adjustments of the range and the acquired data indicating the type of device.

It is needless to say that the method of adjusting the range indicated by range information according to the second example of the evaluation value calculation process according to the third example is not limited to the above example.

(1-3-3) Third Example of the Evaluation Value Calculation Process According to the Third Example

The information processing apparatus according to the present embodiment adjusts the range indicated by range information based on, for example, the position on the display screen corresponding to information about the position of the line of sight of the user and the distance to the user corresponding to information about the position of the line of sight of the user. The information processing apparatus according to the present embodiment may also adjust the range indicated by range information based on, for example, the position on a real object corresponding to information about the position of the line of sight of the user and the distance to the user corresponding to information about the position of the line of sight of the user. Hereinafter, “the position on the display screen corresponding to information about the position of the line of sight of the user and the distance to the user corresponding to information about the position of the line of sight of the user” and “the position on a real object corresponding to information about the position of the line of sight of the user and the distance to the user corresponding to information about the position of the line of sight of the user” according to the third example of the evaluation value calculation process according to the third example may be represented as “the distance according to the third example of the evaluation value calculation process according to the third example”.

The distance according to the third example of the evaluation value calculation process according to the third example is calculated by setting, for example, the position of the user's eye as the reference point. However, the reference position of the user involved in calculation of the distance is not limited to the eye position and may be another position related to the user, for example, the center position of the user's head. The distance according to the third example of the evaluation value calculation process according to the third example is calculated by an external device or the information processing apparatus according to the present embodiment based on, for example, a detection value of a depth sensor using infrared radiation or the like. If the distance according to the third example of the evaluation value calculation process according to the third example can be obtained, the acquisition method of the distance according to the third example of the evaluation value calculation process according to the third example is not limited.

With an increasing distance from the user to an object in the direction of the line of sight, an error of the position of the line of sight based on information about the position of the line of sight of the user is likely to be larger.

Thus, the information processing apparatus according to the present embodiment adjusts the range indicated by range information such that, for example, the range increases with an increasing distance according to the third example of the evaluation value calculation process according to the third example.

More specifically, the information processing apparatus according to the present embodiment adjusts the range indicated by range information such that the range increases in proportion to, for example, the distance according to the third example of the evaluation value calculation process according to the third example. The information processing apparatus according to the present embodiment may adjust the range indicated by range information such that the range increases by identifying the amount of adjustments of the range corresponding to the distance according to the third example of the evaluation value calculation process according to the third example using, for example, a table (or a database) associating the distance according to the third example of the evaluation value calculation process according to the third example and the amount of adjustments of the range. It is needless to say that the method of adjusting the range indicated by range information according to the third example of the evaluation value calculation process according to the third example is not limited to the above example.

(1-3-4) Fourth Example of the Evaluation Value Calculation Process According to the Third Example

The information processing apparatus according to the present embodiment adjusts the range indicated by range information based on, for example, the position of the user corresponding to information about the position of the line of sight of the user with respect to the display screen corresponding to information about the position of the line of sight of the user. The information processing apparatus according to the present embodiment may also adjust the range indicated by range information based on, for example, the position of the user corresponding to information about the position of the line of sight of the user with respect to a real object corresponding to information about the position of the line of sight of the user. Hereinafter, “the position of the user corresponding to information about the position of the line of sight of the user with respect to the display screen corresponding to information about the position of the line of sight of the user” and “the position of the user corresponding to information about the position of the line of sight of the user with respect to a real object corresponding to information about the position of the line of sight of the user” according to the fourth example of the evaluation value calculation process according to the third example may be represented as “the position of the user according to the fourth example of the evaluation value calculation process according to the third example”.

Even if, for example, the movement of the user's eye is the same, the amount of movement of the position of the line of sight based on information about the position of the line of sight of the user becomes larger when not facing the display screen or a real object than when facing the display screen or a real object. That is, with an increasing degree of the user not facing the display screen or a real object, an error of the position of the line of sight based on information about the position of the line of sight of the user is likely to be larger.

Thus, the information processing apparatus according to the present embodiment changes the amount of adjustments of the range indicated by range information based on, for example, the position of the user according to the fourth example of the evaluation value calculation process according to the third example. The information processing apparatus according to the present embodiment adjusts the range indicated by range information such that the range increases with an increasing degree of the user not facing the display screen or a real object.

The position of the user according to the fourth example of the evaluation value calculation process according to the third example is identified (or estimated) by an external device or the information processing apparatus according to the present embodiment based on, for example, a detection value of a depth sensor or a captured image. If the position of the user according to the fourth example of the evaluation value calculation process according to the third example can be obtained, the acquisition method of the position of the user according to the fourth example of the evaluation value calculation process according to the third example is not limited.

More specifically, the information processing apparatus according to the present embodiment identifies (or estimates) the angle with respect to the reference direction set to the display screen or a real object based on, for example, the position of the user according to the fourth example of the evaluation value calculation process according to the third example. The reference direction may be, for example, preset or set based on a captured image in which the display screen or a real object is contained. Then, the information processing apparatus according to the present embodiment adjusts the range indicated by range information by identifying the amount of adjustments of the range corresponding to the identified angle using, for example, a table (or a database) associating the angle and the range. It is needless to say that the method of adjusting the range indicated by range information according to the fourth example of the evaluation value calculation process according to the third example is not limited to the above example.

(1-3-5) Fifth Example of the Evaluation Value Calculation Process According to the Third Example

For example, depending on the method involved in acquisition of information about the position of the line of sight of the user or the function of a device involved in acquisition of information about the position of the line of sight of the user (characteristics of the device, for example, the resolution involved in detection of the position of the line of sight and the like),

Thus, the information processing apparatus according to the present embodiment may also adjust the range indicated by range information based on, for example, one or both of the method involved in acquisition of information about the position of the line of sight of the user and the device involved in acquisition of information about the position of the line of sight of the user.

More specifically, the information processing apparatus according to the present embodiment acquires, for example, data showing the method (for example, ID indicating the method) involved in acquisition of information about the position of the line of sight of the user or data indicating the type of device (for example, the device ID) involved in acquisition of information about the position of the line of sight of the user. The information processing apparatus according to the present embodiment acquires data showing the method involved in acquisition of information about the position of the line of sight of the user and/or data indicating the type of device involved in acquisition of information about the position of the line of sight of the user by communicating with, for example, a device involved in acquisition of information about the position of the line of sight of the user or a server managing devices involved in acquisition of information about the position of the line of sight of the user. If data showing the method involved in acquisition of information about the position of the line of sight of the user and/or data indicating the type of device involved in acquisition of information about the position of the line of sight of the user can be acquired, the acquisition method of data showing the method involved in acquisition of information about the position of the line of sight of the user and data showing the type of device involved in acquisition of information about the position of the line of sight of the user is not limited.

When only data showing the method involved in acquisition of information about the position of the line of sight of the user is acquired, the information processing apparatus according to the present embodiment adjusts the range indicated by range information by identifying the amount of adjustments of the range corresponding to the acquired data showing the method involved in acquisition of information about the position of the line of sight of the user using, for example, a table (or a database) associating data showing the method involved in acquisition of information about the position of the line of sight of the user and the amount of adjustments of the range and the acquired data showing the method involved in acquisition of information about the position of the line of sight of the user.

When only data showing the type of device involved in acquisition of information about the position of the line of sight of the user is acquired, the information processing apparatus according to the present embodiment adjusts the range indicated by range information by identifying the amount of adjustments of the range corresponding to the acquired data showing the type of device involved in acquisition of information about the position of the line of sight of the user using, for example, a table (or a database) associating data showing the type of device involved in acquisition of information about the position of the line of sight of the user and the amount of adjustments of the range and the acquired data showing the type of device involved in acquisition of information about the position of the line of sight of the user.

When both of data showing the method involved in acquisition of information about the position of the line of sight of the user and data showing the type of device involved in acquisition of information about the position of the line of sight of the user are acquired, the information processing apparatus according to the present embodiment adjusts the range of range information by identifying the amount of adjustments of the range corresponding to the acquired “data showing the method involved in acquisition of information about the position of the line of sight of the user and data showing the type of device involved in acquisition of information about the position of the line of sight of the user” using, for example, a “table (or a database) associating data showing the method involved in acquisition of information about the position of the line of sight of the user, data showing the type of device involved in acquisition of information about the position of the line of sight of the user, and the amount of adjustments of the range” and the acquired “data showing the method involved in acquisition of information about the position of the line of sight of the user and data showing the type of device involved in acquisition of information about the position of the line of sight of the user”.

It is needless to say that the method of adjusting the range indicated by range information according to the fifth example of the evaluation value calculation process according to the third example is not limited to the above example.

(1-3-6) Sixth Example of the Evaluation Value Calculation Process According to the Third Example

The information processing apparatus according to the present embodiment can also adjust the range of range information by identifying the amount of adjustments of the range based on a process combining two or more processes from, for example, the second example of the evaluation value calculation process according to the third example to the fifth example of the evaluation value calculation process according to the third example. When a plurality of processes is combined, the information processing apparatus according to the present embodiment may assign priority or weights of the amount of adjustments of the range to each process.

(1-4) Fourth Example of the Evaluation Value Calculation Process

The information processing apparatus according to the present embodiment can also perform a process combining, for example, the evaluation value calculation process according to the second example shown in (1-2) and the evaluation value calculation process according to the third example shown in (1-3) as the evaluation value calculation process according to the present embodiment.

The information processing apparatus according to the present embodiment calculates an evaluation value for each identified range of calculating an evaluation value according to the present embodiment based on information about the position of the line of sight of the user and range information by performing an evaluation value calculation process according to the present embodiment like, for example, the evaluation value calculation process according to the first example shown in (1-1) to the evaluation value calculation process according to the fourth example shown in (1-4) as a process related to the information processing method according to the present embodiment.

Therefore, the information processing apparatus according to the present embodiment can calculate an evaluation value concerning the line of sight of the user based on the position of the line of sight of the user.

Processing related to the information processing method according to the present embodiment is not limited to the process (evaluation value calculation process) shown in (1). For example, the information processing apparatus according to the present embodiment can further perform one or both of a generation process as a process involved in generation of range information according to the present embodiment and an execution process as a process using an evaluation value according to the present embodiment as processing related to the information processing method according to the present embodiment.

(2) Generation Process

For example, the information processing apparatus according to the present embodiment sets the range of calculating an evaluation value and generates range information corresponding to the set range.

The information processing apparatus according to the present embodiment sets, for example, the range specified based on a user's operation as the range according to the present embodiment. The range based on a user's operation can be specified by using any interface allowing a user's operation such as the slider, tab, button and the like.

Citing one example, as a user interface to make the user set the range according to the present embodiment, for example, an interface allowing the display screen to display an image corresponding to an object to which the range of calculating an evaluation value is set (for example, the actually displayed image) to enable the user to perform a pointing operation. As concrete examples of the interface enabling a pointing operation according to the present embodiment, for example, examples shown in (i) and (ii) below can be cited.

(i) An interface allowing, based on a small region selected by the user from identified small regions, to set a region equal to or larger than the small region as a region according to the present embodiment

With an interface according to (i) being used, for example, “among small regions A to Z as a plurality of small regions set to the display screen, the small regions A, B, C as small regions selected by the user are set as regions according to the present embodiment” or the like is realized.

(ii) An interface allowing the range specified by the user to be set as a range according to the present embodiment based on coordinate values corresponding to the range specified by the user

With an interface according to (ii) being used, for example, “the range freely specified by the user is set as a range according to the present embodiment by a rectangular, circular, or free-form range being specified by the user on an image corresponding to an object to which the range of calculating an evaluation value is set” or the like is realized.

The information processing apparatus according to the present embodiment can also analyze the object to which the range of calculating an evaluation value is set and set the range according to the present embodiment based on an analysis result. As an example in which the range according to the present embodiment is set based on an analysis result, for example, as shown in B of FIG. 1 or C of FIG. 1, an example in which the range according to the present embodiment is set in units of articles contained in a page or in units of constituent elements of an article can be cited.

When a generation process according to the present embodiment is performed, the information processing apparatus according to the present embodiment can use, for example, generated range information in the process (evaluation value calculation process) of (1).

Range information generated by a generation process according to the present embodiment may be recorded in a storage unit (not shown) or a recording medium such as an external recording medium. The information processing apparatus according to the present embodiment can also use range information stored in a recording medium in the process (evaluation value calculation process) of (1).

(3) Execution Process

The information processing apparatus according to the present embodiment performs processing based on, for example, an evaluation value calculated for each range according to the present embodiment.

(3-1) First Example of the Execution Process

The information processing apparatus according to the present embodiment generates data compiling each evaluation value calculated for each range according to the present embodiment. The information processing apparatus according to the present embodiment may also cause the display screen to display data compiling generated evaluation values. As the display screen caused to display data compiling evaluation values generated by the information processing apparatus according to the present embodiment, for example, a display unit (described later) included in the information processing apparatus according to the present embodiment and the display screen of an external display device can be cited.

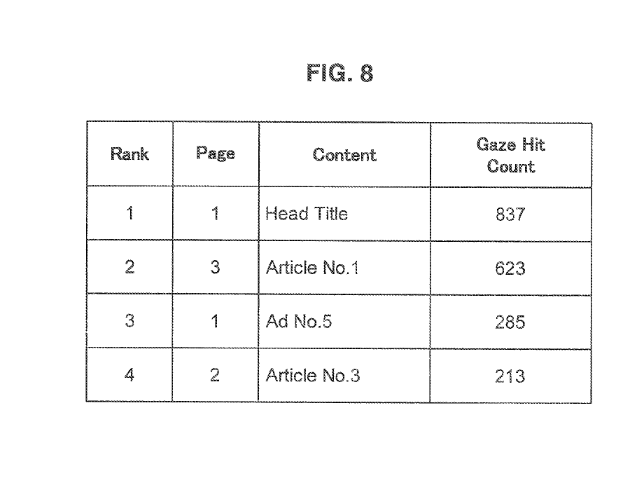

FIG. 8 is an explanatory view illustrating an example of processing related to the information processing method according to the present embodiment and shows an example of data compiling evaluation values generated by the information processing apparatus according to the present embodiment.

The information processing apparatus according to the present embodiment generates, as shown, for example, in FIG. 8, data in which ranges according to the present embodiment are sorted in descending order of evaluation value. The descending order of evaluation value corresponds to, for example, the descending order of attention of the user.

If a case in which the object to which the range to calculate an evaluation value is set is a medium having a plurality of pages such as a magazine, a book or the like is taken as an example, the information processing apparatus according to the present embodiment may generate, for example, data compiling evaluation values of the plurality of pages or generate data compiling evaluation values of any one page. When the object to which the range to calculate an evaluation value is set is another object such as a moving image, the information processing apparatus according to the present embodiment can similarly generate data compiling evaluation values in various units.

(3-2) Second Example of the Execution Process

The information processing apparatus according to the present embodiment causes the display screen to display, for example, a UI (User Interface) related to the analysis of evaluation values calculated for each range according to the present embodiment. As the display screen caused to display the UI related to the analysis of evaluation values according to the present embodiment, for example, a display unit (described later) included in the information processing apparatus according to the present embodiment and the display screen of an external display device can be cited.

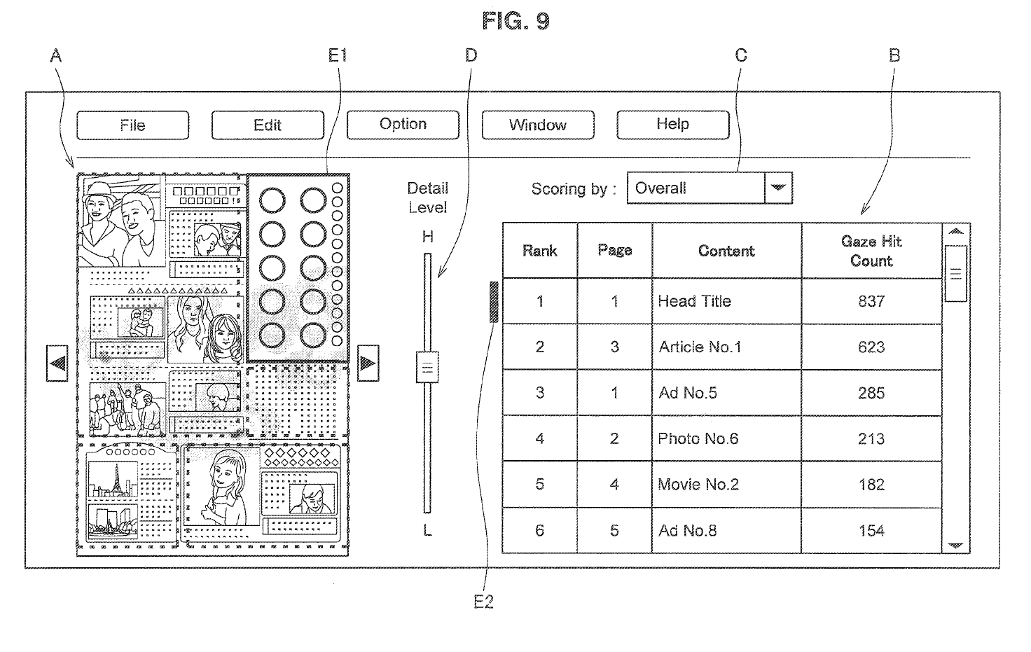

FIG. 9 is an explanatory view illustrating an example of processing related to the information processing method according to the present embodiment and shows an example of the UI related to the analysis of evaluation values the display screen is caused to display by the information processing apparatus according to the present embodiment.

Referring to the example shown in FIG. 9, the UI related to the analysis of evaluation values includes, for example, an object (A shown in FIG. 9) to which the range of calculating an evaluation value is set, data (B shown in FIG. 9) compiling evaluation values, a tab (C shown in FIG. 9) specifying the unit of compiling evaluation values, and a slider (D shown in FIG. 9) adjusting the grain size of the range according to the present embodiment.

For example, as the unit indicated by the tab shown in C of FIG. 9, for example, “Overall (overall compilation)”, “Page (compilation for each page)”, and “Content Type (compilation for each type of content)” can be cited. In addition, various ranges to calculate an evaluation value as shown with reference to, for example, FIG. 1 can be specified by the slider shown in D of FIG. 9. Further, the object (A shown in FIG. 9) to which the range of calculating an evaluation value is set and data (B shown in FIG. 9) compiling evaluation values may be associated as shown, for example, in E1, E2 of FIG. 9.

The information processing apparatus according to the present embodiment may cause the display screen to display, as shown, for example, in A of FIG. 9 and FIGS. 10 and 11, score values involved in calculation of evaluation values (values involved in calculation of evaluation values) by visualization through the color in accordance with the magnitude of the score value.

The visualization through the color in accordance with the magnitude of the score value represents, for example, “how the line of sight of the user is distributed on the display screen or a real object and how long is the dwell time” by color-coding. The visualization through the color in accordance with the magnitude of the score value corresponds to, for example, a visual representation of locations focused on by the user based on the color.

By visualizing the score value, the analyzer who analyzes evaluation values can analyze evaluation values more intuitively.

The example of UI related to the analysis of evaluation values the display screen is caused to display by the information processing apparatus according to the present embodiment is not limited to the example shown in FIG. 9.

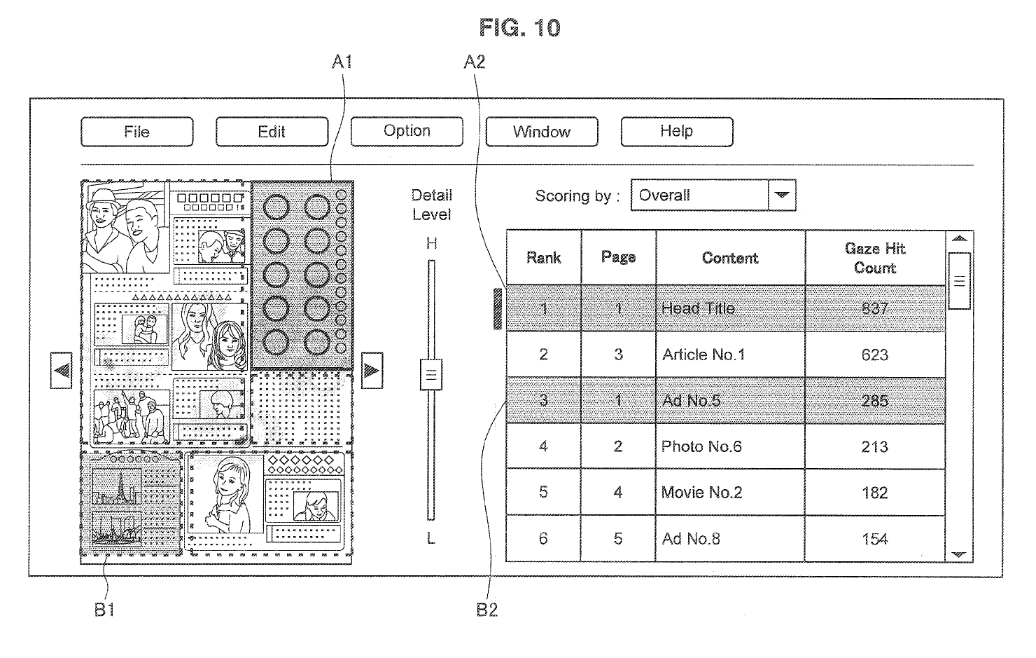

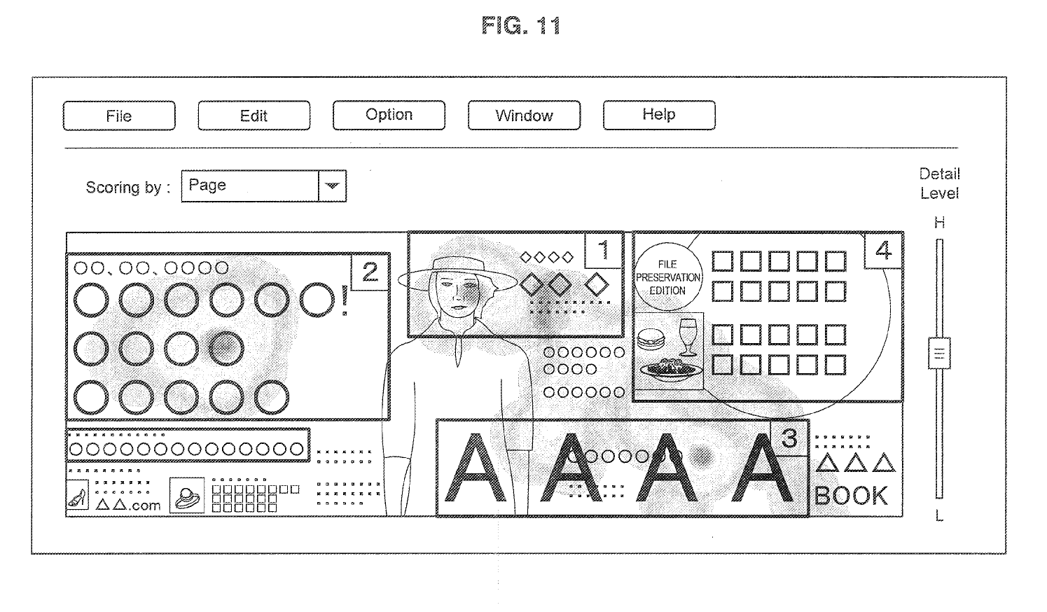

FIGS. 10 and 11 are explanatory views illustrating examples of processing related to the information processing method according to the present embodiment and show other examples of the UI related to the analysis of evaluation values the display screen is caused to display by the information processing apparatus according to the present embodiment.

As shown, for example, in A1, A2, B1, B2 of FIG. 10, the object to which the range of calculating an evaluation value is set and data compiling evaluation values may be associated by color.

Also, as shown, for example, in FIG. 11, the number of ranking based on data compiling evaluation values for ranges according to the present embodiment may be displayed for objects to which the range of calculating an evaluation value is set.

As examples of the UI related to the analysis of evaluation values according to the present embodiment, for example, examples shown in FIGS. 9 to 11 can be cited. However, it is needless to say that examples of the UI related to the analysis of evaluation values according to the present embodiment are not limited to examples shown in FIGS. 9 to 11.

(3-3) Third Example of the Execution Process

The information processing apparatus according to the present embodiment extracts an object that attracts the user's attention from objects contained in the object to which the range of calculating an evaluation value is set based on, for example, the object to which the range of calculating an evaluation value is set and score values involved in calculation of evaluation values (values involved in calculation of evaluation values). Then, the information processing apparatus according to the present embodiment causes the display screen to display, for example, goods corresponding to the extracted object as recommended goods. As the display screen caused to display recommended goods according to the present embodiment, for example, a display unit (described later) included in the information processing apparatus according to the present embodiment and the display screen of an external display device can be cited.

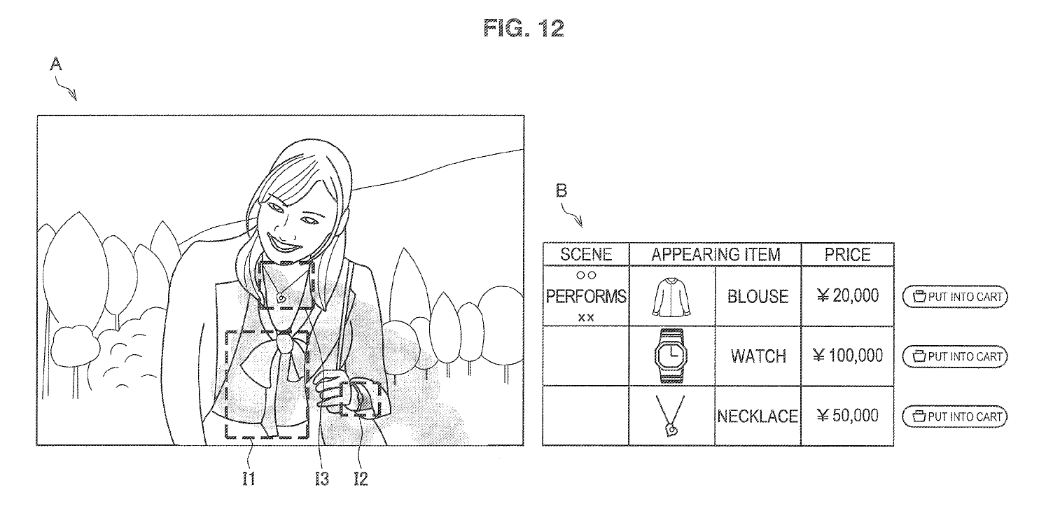

FIG. 12 is an explanatory view illustrating an example of processing related to an information processing method according to the present embodiment. A shown in FIG. 12 shows an example in which locations that attract the user's attention are visualized by colors in accordance with the magnitude of the score value for the object to which the range of calculating an evaluation value is set. B shown in FIG. 12 shows an example of recommended goods the display screen is caused to display by the information processing apparatus according to the present embodiment.

FIG. 12 shows an example in which a blouse, a watch, and a necklace corresponding to I1 to I3 shown in A of FIG. 12 are displayed, as shown in B of FIG. 12, as recommended goods on the display screen.

(3-4) Fourth Example of the Execution Process

The information processing apparatus according to the present embodiment identifies content contained in the object to which the range of calculating an evaluation value is set and on which the user's attention is focused based on, for example, “evaluation values and/or score values involved in calculation of evaluation values (values involved in calculation of evaluation values)” and an “object to which the range of calculating an evaluation value is set”. The information processing apparatus according to the present embodiment identifies, of content contained in the object to which the range of calculating an evaluation value is set, for example, content of a high evaluation value and/or content of a high evaluation value involved in calculation of an evaluation value as content that attracted the user's attention.

Then, the information processing apparatus according to the present embodiment presents, for example, other content related to the identified content that attracted the user's attention to the user. The information processing apparatus according to the present embodiment presents other content to the user by causing, for example, the display screen of a display unit (described later) included in the information processing apparatus according to the present embodiment or the display screen of an external display device to display an image related to the other content.

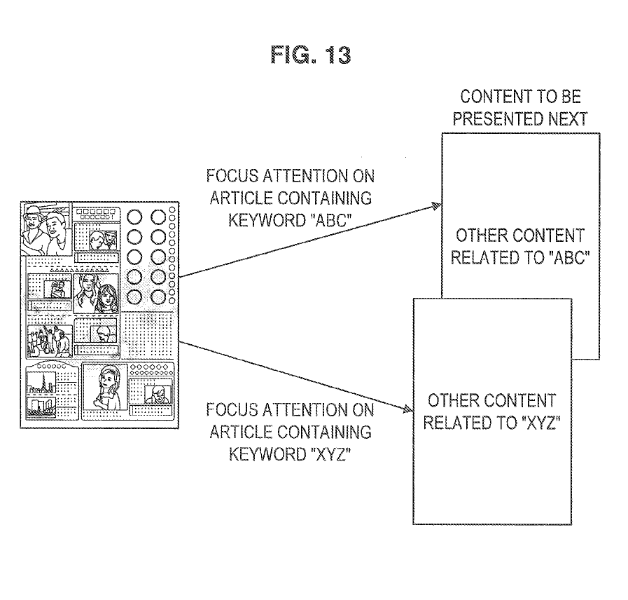

FIG. 13 is an explanatory view illustrating an example of processing related to the information processing method according to the present embodiment and shows an overview of other content presented by an execution process according to the fourth example being performed by the information processing apparatus according to the present embodiment.

When, for example, the user is determined to focus his (her) attention on an article (example of content) containing a keyword “ABC”, the information processing apparatus according to the present embodiment presents other content related to the keyword “ABC”. Also when, for example, the user is determined to focus his (her) attention on an article (example of content) containing a keyword “XYZ”, the information processing apparatus according to the present embodiment presents other content related to the keyword “XYZ”.

(3-5) Fifth Example of the Execution Process

The information processing method according to the present embodiment causes transmission of, for example, evaluation values calculated by the process (evaluation value calculation process) in (1) or score values involved in calculation of evaluation values (values involved in calculation of evaluation values) to an external device such as a server. Also, the information processing method according to the present embodiment may further cause transmission of data showing objects to which the range of calculating an evaluation value is set to an external device such as a server.

The information processing method according to the present embodiment causes, for example, a communication unit (described later) included in the information processing method according to the present embodiment or an external communication device to transmit data showing evaluation values or score values to an external device such as a server.

Data showing evaluation values or score values transmitted by the information processing apparatus according to the present embodiment plays the role of, for example, a log concerning the line of sight of the user. Hereinafter, data showing evaluation values or score values transmitted from the information processing apparatus according to the present embodiment may be represented as a “content/line-of-sight log”.

When the information processing apparatus according to the present embodiment performs an execution process according to the fifth example, for example, an information processing system as shown below can be realized.

### Example of the Information Processing System According to the Present Embodiment

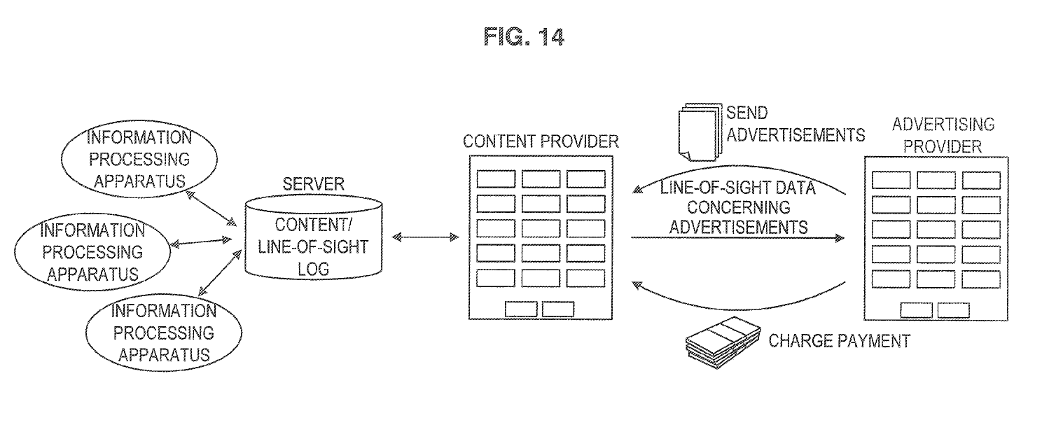

FIG. 14 is an explanatory view illustrating an example of the information processing system according to the present embodiment. FIG. 14 shows an information processing system according to the present embodiment having a “mechanism in which how much gaze is cast over which advertisement is analyzed and advertisement rates are decided based on analysis results”.

An information processing system according to the present embodiment includes an information processing apparatus according to the present embodiment, a server that manages a content/line-of-sight log, a content provider that provides content, and an advertising provider that provides advertisements.

FIG. 14 shows a configuration in which the information processing system includes three information processing apparatuses according to the present embodiment, but the number of information processing apparatuses included in the information processing system according to the present embodiment is not limited to three. The information processing system according to the present embodiment can also take a configuration in which one or two information processing apparatuses according to the present embodiment are included.

In the information processing system according to the present embodiment shown in FIG. 14, the advertising provider sends advertisements to the content provider. Also in the information processing system according to the present embodiment shown in FIG. 14, the content provider provides line-of-sight data of sent advertisements to the advertising provider. Then, the advertising provider pays charges in accordance with line-of-sight data of sent advertisements to the content provider as advertisement rates.

As the line-of-sight data according to the present embodiment, for example, data containing data showing evaluation values or score values transmitted by the information processing apparatus according to the present embodiment can be cited. In addition, the line-of-sight data according to the present embodiment may contain data showing the time when data showing evaluation values or score values transmitted by the information processing apparatus according to the present embodiment is stored on a server.

As the method of deciding advertisement rates according to the present embodiment, for example, methods shown below can be cited:

The content provider computes score values related to the gaze cast over advertisements collected from each of information processing apparatuses according to the present embodiment in divided periods.

Advertisement rates paid from the advertising provider to the content provider are, for example, charges calculated by multiplying the total of score values by the score unit price.

The score unit price according to the present embodiment is set based on, for example, one or two or more parameters such as the size of advertisements, location, number of colors, resolution and the like. When an advertisement is shown as a moving image, the score unit price according to the present embodiment may further be set based on the reproduction time.

However, the method of deciding advertisement rates is not limited to the above examples. For example, advertisement rates according to the present embodiment may be standard charges in accordance with parameters as shown above while the score unit price is fixed. When advertisement rates according to the present embodiment are standard charges, for example, the advertising provider can pay charges to the content provider in advance.

When, for example, advertisement rates are decided based on line-of-sight data according to the present embodiment in the information processing system according to the present embodiment shown in FIG. 14, it is necessary for the content provider to obtain line-of-sight data according to the present embodiment. For the content provider to obtain line-of-sight data according to the present embodiment, for example, it is necessary to guide the user's face into the detection range of a device involved in detection of the line of sight of the user viewing text or an image. Particularly when the device in which text or an image over which the user casts his (her) gaze is displayed is a so-called portable device like a tablet apparatus or a communication apparatus such as a smartphone, the user is quite likely to be guided like holding or placing the portable device such that the face falls into the detection range of the device involved in detection of the line of sight.

Therefore, in the information processing system according to the present embodiment, for example, the user is guided to maintain a state of line-of-sight detection by giving an incentive to the user.

Incentives given to the user in the information processing system according to the present embodiment include, for example, examples shown below:

The user is allowed to browse or use content or applications reserved for fee-charging members without charge or at discount prices on condition that the use thereof is enabled only while a line of sight is detected.

To provide special content displayed only when a line of sight is detected.

To give a benefit such as points in accordance with the accumulated time in which a line of sight is detected or the ratio of time in which a line of sight can be detected to the content browsing time.

The content provider decides the budget of incentives given to the user in the information processing system according to the present embodiment in consideration of, for example, content production costs, server operation costs, necessary expenses and the like from advertisement rates expected to be received from the advertising provider.

As the method of deciding the scale of incentives during operation of the information processing system according to the present embodiment, for example, examples shown below can be cited. Examples shown below are examples when bonus points are given as incentives.

Decision in stages: for example, one point after viewing three seconds, three points after viewing eight seconds, and six points after viewing 15 seconds

Decision by multiplying the time in which a line of sight is detected by the point unit: For example, number of points given=(time in which a line of sight is detected)×(number of points per unit time)

In each of the example of decision in stages and the example of decision by multiplying the time in which the line of sight is detected by the point unit, an upper limit is set to the number of points given.

As an example of the information processing system according to the present embodiment, for example, the information processing system according to the present embodiment having a “mechanism in which how much gaze is cast over which advertisement is analyzed and advertisement rates are decided based on analysis results” as shown in FIG. 14 can be cited. However, it is needless to say that the information processing system according to the present embodiment is not limited to the example shown in FIG. 14.

### Information Processing Apparatus According to the Present Embodiment

Next, an example of the configuration of an information processing apparatus according to the present embodiment capable of performing the processing according to the information processing method according to the present embodiment described above will be described.

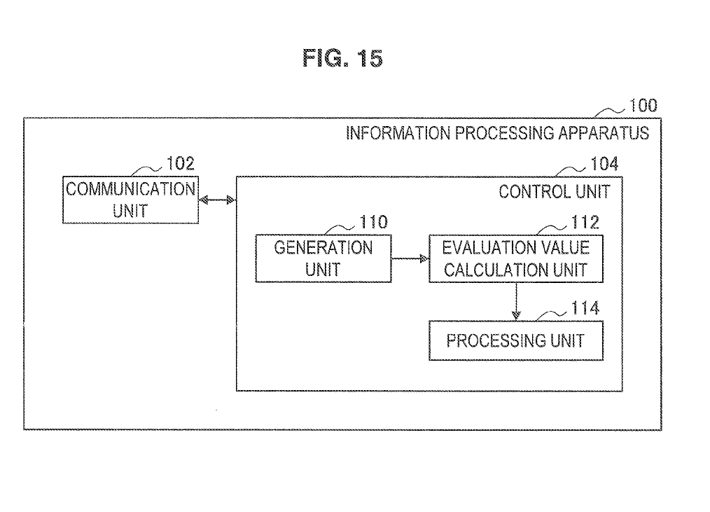

FIG. 15 is a block diagram showing an example of the configuration of an information processing apparatus 100 according to the present embodiment. The information processing apparatus 100 includes, for example, a communication unit 102 and a control unit 104.

The information processing apparatus 100 may also include, for example, ROM (Read Only Memory, not shown), RAM (Random Access Memory, not shown), a storage unit (not shown), an operation unit (not shown) that can be operated by the user, and a display unit (not shown) that displays various screens on the display screen. The information processing apparatus 100 connects each of the above elements by, for example, a bus as a transmission path.

The ROM (not shown) stores programs used by the control unit 104 and control data such as operation parameters. The RAM (not shown) temporarily stores programs executed by the control unit 104 and the like.

The storage unit (not shown) is a storage means included in the information processing apparatus 100 and stores, for example, data related to the information processing method according to the present embodiment such as range information according to the present embodiment, and various data such as applications. As the storage unit (not shown), for example, a magnetic recording medium such as a hard disk and nonvolatile memory such as flash memory can be cited. The storage unit (not shown) may be removable from the information processing apparatus 100.

As the operation unit (not shown), an operation input device described later can be cited. As the display unit (not shown), a display device described later can be cited.

(Hardware Configuration Example of the Information Processing Apparatus 100)

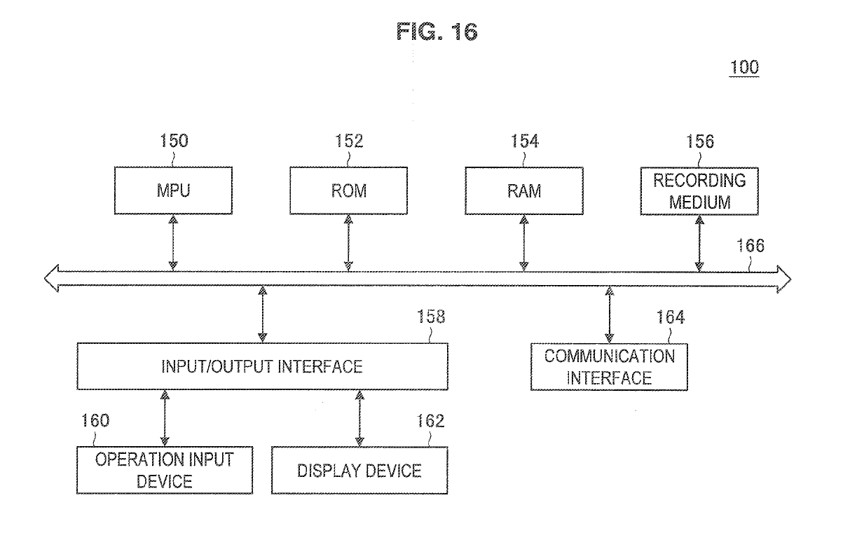

FIG. 16 is an explanatory view showing an example of the hardware configuration of the information processing apparatus 100 according to the present embodiment. The information processing apparatus 100 includes, for example, an MPU 150, ROM 152, RAM 154, a recording medium 156, an input/output interface 158, an operation input device 160, a display device 162, and a communication interface 164. The information processing apparatus 100 connects each structural element by, for example, a bus 166 as a transmission path of data.

The MPU 150 is configured by a processor configured by an operation circuit such as an MPU (Micro Processing Unit) and various processing circuits and functions as the control unit 104 the controls the whole information processing apparatus 100. The MPU 150 plays the role of, for example, a generation unit 110, an evaluation value calculation unit 112, and a processing unit 114 described later in the information processing apparatus 100.

The ROM 152 stores programs used by the MPU 150 and control data such as operation parameters. The RAM 154 temporarily stores programs executed by the MPU 150 and the like.

The recording medium 156 functions as a storage unit (not shown) and stores, for example, data related to the information processing method according to the present embodiment such as range information according to the present embodiment, and various data such as applications. As the recording medium 156, for example, a magnetic recording medium such as a hard disk and nonvolatile memory such as a flash memory can be cited. The recording medium 156 may be removable from the information processing apparatus 100.

The input/output interface 158 connects, for example, the operation input device 160 and the display device 162. The operation input device 160 functions as an operation unit (not shown) and the display device 162 functions as a display unit (not shown). As the input/output interface 158, for example, a USB (Universal Serial Bus) terminal, a DVI (Digital Visual Interface) terminal, an HDMI (High-Definition Multimedia Interface) (registered trademark) terminal, and various processing circuits can be cited.

The operation input device 160 is, for example, included in the information processing apparatus 100 and connected to the input/output interface 158 inside the information processing apparatus 100. As the operation input device 160, for example, a button, a direction key, a rotary selector such as a jog dial, and a combination of these devices can be cited.

The display device 162 is, for example, included in the information processing apparatus 100 and connected to the input/output interface 158 inside the information processing apparatus 100. As the display device 162, for example, a liquid crystal display and an organic electro-luminescence display (also called an OLED display (Organic Light Emitting Diode Display)) can be cited.

It is needless to say that the input/output interface 158 can also be connected to an external device such as an operation input device (for example, a keyboard and a mouse) and a display device as an external apparatus of the information processing apparatus 100. The display device 162 may be a device capable of both the display and user operations like, for example, a touch screen.

The communication interface 164 is a communication means included in the information processing apparatus 100 and functions as the communication unit 102 to communicate with an external device or an external apparatus such as an external imaging device, an external display device such as a server, and an external sensor via a network (or directly) wirelessly or through a wire. As the communication interface 164, for example, a communication antenna and RF (Radio Frequency) circuit (wireless communication), an IEEE802.15.1 port and transmitting/receiving circuit (wireless communication), an IEEE802.11 port and transmitting/receiving circuit (wireless communication), and a LAN (Local Area Network) terminal and transmitting/receiving circuit (wire communication) can be cited. As the network according to the present embodiment, for example, a wire network such as LAN and WAN (Wide Area Network), a wireless network such as wireless LAN (WLAN: Wireless Local Area Network) and wireless WAN (WWAN: Wireless Wide Area Network) via a base station, and the Internet using the communication protocol such as TCP/IP (Transmission Control Protocol/Internet Protocol) can be cited.

With the configuration shown in, for example, FIG. 16, the information processing apparatus 100 performs processing according to the information processing method according to the present embodiment. However, the hardware configuration of the information processing apparatus 100 according to the present embodiment is not limited to the configuration shown in FIG. 16.

The information processing apparatus 100 may include, for example, an imaging device playing the role of an imaging unit (not shown) that captures moving images or still images. When an imaging device is included, for example, the information processing apparatus 100 can obtain information about a position of a line of sight of the user by processing a captured image generated by imaging in the imaging device.

As the imaging device according to the present embodiment, for example, a lens/image sensor and a signal processing circuit can be cited. The lens/image sensor is constituted of, for example, an optical lens and an image sensor using a plurality of image sensors such as CMOS (Complementary Metal Oxide Semiconductor). The signal processing circuit includes, for example, an AGC (Automatic Gain Control) circuit or an ADC (Analog to Digital Converter) to convert an analog signal generated by the image sensor into a digital signal (image data). The signal processing circuit may also perform various kinds of signal processing, for example, the white balance correction processing, tone correction processing, gamma correction processing, YCbCr conversion processing, and edge enhancement processing.

The information processing apparatus 100 may further include, for example, a sensor plating the role of a detection unit (not shown) that obtains data that can be used to identify the position of the line of sight of the user according to the present embodiment. When such a sensor is included, the information processing apparatus 100 can improve the estimation accuracy of the position of the line of sight of the user by using, for example, data obtained from the sensor.

As the sensor according to the present embodiment, for example, any sensor that obtains detection values that can be used to improve the estimation accuracy of the position of the line of sight of the user such as an infrared ray sensor can be cited.

When configured to, for example, perform processing on a standalone basis, the information processing apparatus 100 may not include the communication interface 164. The information processing apparatus 100 may also be configured not to include the recording medium 156, the operation device 160, or the display device 162.

Referring to FIG. 15, an example of the configuration of the information processing apparatus 100 will be described. The communication unit 102 is a communication means included in the information processing apparatus 100 and communicates with an external device such as an external imaging device, an external display device, and an external sensor, and an external apparatus such as a server via a network (or directly) wirelessly or through a wire. Communication of the communication unit 102 is controlled by, for example, the control unit 104.

As the communication unit 102, for example, a communication antenna and RF circuit and a LAN terminal and transmitting/receiving circuit can be cited, but the configuration of the communication unit 102 is not limited to the above example. For example, the communication unit 102 may adopt a configuration conforming to any standard capable of communication such as a USB terminal and transmitting/receiving circuit or any configuration capable of communicating with an external apparatus via a network.

The control unit 104 is configured by, for example, an MPU and plays the role of controlling the whole information processing apparatus 100. The control unit 104 includes, for example, the generation unit 110, the evaluation value calculation unit 112, and the processing unit 114 and plays the role of taking the lead in processing related to an information processing method according to the present embodiment.

The generation unit 110 plays the role of taking the lead in the process (generation process) in (2). The generation unit 110, for example, sets a range according to the present embodiment and generates range information corresponding to the set range.

The evaluation value calculation unit 112 plays the role of taking the lead in the process (evaluation value calculation process) in (1) and calculates an evaluation value for each identified range according to the present embodiment based on information about the position of the line of sight of the user and range information. More specifically, the evaluation value calculation unit 112 performs, for example, one of the evaluation value calculation process according to the first example shown in (1-1) to the evaluation value calculation process according to the fourth example shown in (1-4).

The evaluation value calculation unit 112 uses, for example, range information generated by the generation unit 110 and/or range information stored in a storage unit (not shown) or an external recording medium for processing. The evaluation value calculation unit 112 can also use range information acquired from, for example, the communication unit 102 or an external device via an external communication device for processing.

The processing unit 114 plays the role of taking the lead in the process (execution process) in (3) and performs processing based on, for example, an evaluation value calculated for each range according to the present embodiment. The processing unit 114 can also perform processing based on, for example, score values involved in calculation of evaluation values (values involved in calculation of evaluation values).

More specifically, the processing unit 114 performs, for example, one or two or more from the execution process according to the first example shown in (3-1) to the evaluation value calculation process according to the fifth example shown in (3-5).

By including, for example, the generation unit 110, the evaluation value calculation unit 112, and the processing unit 114, the control unit 104 takes the lead in processing related to the information processing method according to the present embodiment.

With the configuration shown in, for example, FIG. 15, the information processing apparatus 100 performs processing (for example, the process (evaluation value calculation process) in (1) to the process (execution process) in (3)) related to the information processing method according to the present embodiment.

Therefore, the information processing apparatus 100 according to the present embodiment can calculate an evaluation value concerning the line of sight of the user based on the position of the line of sight of the user by using, for example, the configuration shown in FIG. 15.

Also with the configuration shown in, for example, FIG. 15, the information processing apparatus 100 can achieve effects that can be achieved by, for example, the above processing according to the information processing method according to the present embodiment being performed.

However, the configuration of the information processing apparatus according to the present embodiment is not limited to the configuration in FIG. 15.

For example, the information processing apparatus according to the present embodiment can include one or two or more of the generation unit 110, the evaluation value calculation unit 112, and the processing unit 114 shown in FIG. 15 separately from the control unit 104 (for example, realized by another processing circuit).

The information processing apparatus according to the present embodiment can also adopt a configuration in which, for example, one or both of the generation unit 110 and the processing unit 114 shown in FIG. 15 are not included. Even if a configuration in which one or both of the generation unit 110 and the processing unit 114 are not included is adopted, the information processing apparatus according to the present embodiment can perform the process (evaluation value calculation process) in (1). Therefore, even if configured not to include one or both of the generation unit 110 and the processing unit 114, the information processing apparatus according to the present embodiment can calculate an evaluation value concerning the line of sight of the user based on the position of the line of sight of the user.

The information processing apparatus according to the present embodiment may not include the communication unit 102 when communicating with an external device or an external apparatus via an external communication device having the function and configuration similar to those of the communication unit 102 or when configured to perform processing on a standalone basis.

The information processing apparatus according to the present embodiment may further include, for example, an imaging unit (not shown) configured by an imaging device. When an imaging unit (not shown) is included, the information processing apparatus according to the present embodiment can obtain information about a position of a line of sight of the user by processing a captured image generated by imaging in the imaging unit (not shown).

The information processing apparatus according to the present embodiment may further include, for example, a detection unit (not shown) configured by any sensor that obtains detection values that can be used to improve the estimation accuracy of the position of the line of sight of the user. When a detection unit (not shown) is included, the information processing apparatus according to the present embodiment can improve the estimation accuracy of the position of the line of sight of the user by using, for example, data obtained from the detection unit (not shown).

In the foregoing, the information processing apparatus has been described as the present embodiment, but the present embodiment is not limited to such a form. The present embodiment can also be applied to various devices, for example, a TV set, a display apparatus, a tablet apparatus, a communication apparatus such as a mobile phone and smartphone, transmission type or shielding type HMD, a video/music playback apparatus (or a video/music recording and playback apparatus), a game machine, and a computer such as a PC (Personal Computer). The present embodiment can also be applied to, for example, a processing IC (Integrated Circuit) that can be embedded in devices as described above.

The present embodiment may also be realized by a system including a plurality of apparatuses predicated on connection to a network (or communication between each apparatus) like, for example, cloud computing. That is, the above information processing apparatus according to the present embodiment can be realized as, for example, an information processing system including a plurality of apparatuses.

### Program According to the Present Embodiment

An evaluation value concerning the line of sight of the user can be calculated based on the position of the line of sight of the user by a program (program capable of performing processing related to the information processing method according to the present embodiment like, for example, “the process (evaluation value calculation process) in (1)”, “the process (evaluation value calculation process) in (1) and the process (generation process) in (2)”, “the process (evaluation value calculation process) in (1) and the process (execution process) in (3)”, and “the process (evaluation value calculation process) in (1) to the process (execution process) in (3)”) causing a computer to function as an information processing apparatus according to the present embodiment being executed by a processor or the like in the computer.

Also, effects achieved by the above processing according to the information processing method according to the present embodiment can be achieved by a program causing a computer to function as an information processing apparatus according to the present embodiment being performed by a processor or the like in the computer.

In the foregoing, the preferred embodiment of the present disclosure has been described in detail with reference to the accompanying drawings, but the technical scope of the present disclosure is not limited to the above examples. A person skilled in the art may find various alterations and modifications within the scope of the appended claims and it should be understood that they will naturally come under the technical scope of the present disclosure.

For example, the above shows that a program (computer program) causing a computer to function as an information processing apparatus according to the present embodiment is provided, but the present embodiment can further provide a recording medium caused to store the program.

The above configuration shows an example of the present embodiment and naturally comes under the technical scope of the present disclosure.

Effects described in this specification are only descriptive or illustrative and are not restrictive. That is, the technology according to the present disclosure can achieve other effects obvious to a person skilled in the art from the description of this specification, together with the above effects or instead of the above effects.

Additionally, the present disclosure can also be configured as follows.
(1) An information processing apparatus including:

an evaluation value calculation unit configured to calculate an evaluation value for each range identified based on information about a position of a line of sight of a user and range information indicating the range of calculating the evaluation value concerning the line of sight.
(2) The information processing apparatus according to (1),

wherein the evaluation value calculation unit calculates the evaluation value by assigning weights to the range identified.
(3) The information processing apparatus according to (2),

wherein the evaluation value calculation unit calculates the evaluation value by assigning weights based on one or both of a type of content contained in the range identified and attributes of the content.
(4) The information processing apparatus according to (2) or (3),

wherein, when the range indicated by the range information is a partial region of a region corresponding to a display screen, the evaluation value calculation unit calculates the evaluation value by assigning weights based on a distance of the region corresponding to the range identified based on the range information from a reference position on the display screen.
(5) The information processing apparatus according to (4),

wherein the reference position is set based on a type of content to which the range identified based on the range information is set.
(6) The information processing apparatus according to any one of (1) to (5),

wherein, when the range indicated by the range information is a partial region of a region corresponding to a display screen, the evaluation value calculation unit identifies the range by adjusting the range indicated by the range information in a manner that the range increases after each of the ranges.
(7) The information processing apparatus according to (6),

wherein the evaluation value calculation unit adjusts the range indicated by the range information based on a type of a device corresponding to the information about the position of the line of sight of the user.
(8) The information processing apparatus according to (6) or (7),

wherein the evaluation value calculation unit adjusts the range indicated by the range information based on the position on a display screen corresponding to the information about the position of the line of sight of the user or the position on a real object corresponding to the information about the position of the line of sight of the user and a distance to the user corresponding to the information about the position of the line of sight of the user.
(9) The information processing apparatus according to any one of (6) to (8),

wherein the evaluation value calculation unit adjusts the range indicated by the range information based on the position of the user corresponding to the information about the position of the line of sight of the user on a display screen corresponding to the information about the position of the line of sight of the user or a real object corresponding to the information about the position of the line of sight of the user.
(10) The information processing apparatus according to any one of (6) to (9),

wherein the evaluation value calculation unit adjusts the range indicated by the range information based on one or both of a method involved in acquisition of the information about the position of the line of sight of the user and a device involved in the acquisition of the information about the position of the line of sight of the user.
(11) The information processing apparatus according to any one of (6) to (10),

wherein, when the range is identified by being adjusted, the evaluation value calculation unit calculates the evaluation value by assigning weights to the range of the range adjusted corresponding to a difference between the range adjusted and the range indicated by the range information.
(12) The information processing apparatus according to any one of (1) to (5),

wherein the evaluation value calculation unit identifies the range indicated by the range information as the range.
(13) The information processing apparatus according to any one of (1) to (12), further including:

a generation unit configured to set the range of calculating the evaluation value and to generate the range information corresponding to the range set,

wherein the evaluation value calculation unit calculates the evaluation value based on the range information generated.
(14) The information processing apparatus according to any one of (1) to (13), further including:

a processing unit configured to perform processing based on the evaluation value calculated for each of the ranges.
(15) The information processing apparatus according to (14),

wherein the processing unit causes a display screen to display a value involved in calculation of the evaluation value by visualization through a color in accordance with magnitude of the value involved in the calculation of the evaluation value.
(16) An information processing method executed by an information processing apparatus including:

calculating an evaluation value for each range identified based on information about a position of a line of sight of a user and range information indicating the range of calculating the evaluation value concerning the line of sight.
(17) A program causing a computer to execute:

calculating an evaluation value for each range identified based on information about a position of a line of sight of a user and range information indicating the range of calculating the evaluation value concerning the line of sight.

What is claimed is:

1. An information processing apparatus comprising:
an evaluation value calculation unit configured to calculate an evaluation value for each range identified based on information about a position of a line of sight of a user and range information indicating the range of calculating the evaluation value concerning the line of sight.

2. The information processing apparatus according to claim 1,
wherein the evaluation value calculation unit calculates the evaluation value by assigning weights to the range identified.

3. The information processing apparatus according to claim 2,
wherein the evaluation value calculation unit calculates the evaluation value by assigning weights based on one or both of a type of content contained in the range identified and attributes of the content.

4. The information processing apparatus according to claim 2,
wherein, when the range indicated by the range information is a partial region of a region corresponding to a display screen, the evaluation value calculation unit calculates the evaluation value by assigning weights based on a distance of the region corresponding to the range identified based on the range information from a reference position on the display screen.

5. The information processing apparatus according to claim 4,
wherein the reference position is set based on a type of content to which the range identified based on the range information is set.

6. The information processing apparatus according to claim 1,
wherein, when the range indicated by the range information is a partial region of a region corresponding to a display screen, the evaluation value calculation unit identifies the range by adjusting the range indicated by the range information in a manner that the range increases after each of the ranges.

7. The information processing apparatus according to claim 6,
wherein the evaluation value calculation unit adjusts the range indicated by the range information based on a type of a device corresponding to the information about the position of the line of sight of the user.

8. The information processing apparatus according to claim 6,
wherein the evaluation value calculation unit adjusts the range indicated by the range information based on the position on a display screen corresponding to the information about the position of the line of sight of the user or the position on a real object corresponding to the information about the position of the line of sight of the user and a distance to the user corresponding to the information about the position of the line of sight of the user.

9. The information processing apparatus according to claim 6,
wherein the evaluation value calculation unit adjusts the range indicated by the range information based on the position of the user corresponding to the information about the position of the line of sight of the user on a display screen corresponding to the information about the position of the line of sight of the user or a real object corresponding to the information about the position of the line of sight of the user.

10. The information processing apparatus according to claim 6,
wherein the evaluation value calculation unit adjusts the range indicated by the range information based on one or both of a method involved in acquisition of the information about the position of the line of sight of the user and a device involved in the acquisition of the information about the position of the line of sight of the user.

11. The information processing apparatus according to claim 6,
wherein, when the range is identified by being adjusted, the evaluation value calculation unit calculates the evaluation value by assigning weights to the range of the range adjusted corresponding to a difference between the range adjusted and the range indicated by the range information.

12. The information processing apparatus according to claim 1,
wherein the evaluation value calculation unit identifies the range indicated by the range information as the range.

13. The information processing apparatus according to claim 1, further comprising:
a generation unit configured to set the range of calculating the evaluation value and to generate the range information corresponding to the range set,
wherein the evaluation value calculation unit calculates the evaluation value based on the range information generated.

14. The information processing apparatus according to claim 1, further comprising:
a processing unit configured to perform processing based on the evaluation value calculated for each of the ranges.

15. The information processing apparatus according to claim 14,
wherein the processing unit causes a display screen to display a value involved in calculation of the evaluation value by visualization through a color in accordance with magnitude of the value involved in the calculation of the evaluation value.

16. An information processing method executed by an information processing apparatus comprising:
calculating an evaluation value for each range identified based on information about a position of a line of sight of a user and range information indicating the range of calculating the evaluation value concerning the line of sight.

17. A program causing a computer to execute:
calculating an evaluation value for each range identified based on information about a position of a line of sight of a user and range information indicating the range of calculating the evaluation value concerning the line of sight.
